(19) United States
(12) Patent Application Publication
(10) Pub. No.: US 2024/0405988 A1
(43) Pub. Date: Dec. 5, 2024

(54) DATA PROCESSING METHOD AND APPARATUS

(71) Applicant: Alipay (Hangzhou) Information Technology Co., Ltd., Hangzhou (CN)

(72) Inventor: Xinyi FU, Hangzhou (CN)

(21) Appl. No.: 18/804,621

(22) Filed: Aug. 14, 2024

Related U.S. Application Data
(63) Continuation of application No. PCT/CN2023/071175, filed on Jan. 9, 2023.

(30) Foreign Application Priority Data
Feb. 18, 2022 (CN) 202210150924.4

(51) Int. Cl. H04L 9/32; H04L 9/06

(52) U.S. Cl. CPC H04L 9/321; H04L 9/0618

(57) ABSTRACT

A data processing method is applied to a terminal device, and includes: obtaining service data of a target service by using a trusted application corresponding to the target service, and transferring the service data to a trusted execution environment of the terminal device, where a privacy preserving rule for performing differential privacy processing on the service data of the target service is set in the trusted execution environment of the terminal device; performing differential privacy processing on the service data of the target service based on the privacy preserving rule in the trusted execution environment of the terminal device, to obtain differential privacy-based service data; and transferring the differential privacy-based service data to a trusted execution environment of a server, to trigger the server to obtain risk label information corresponding to the service data, and to determine risk information corresponding to the service data of the target service based on the risk label information and the differential privacy-based service data in the trusted execution environment of the server.

### CROSS-REFERENCE TO RELATED APPLICATIONS

This application is a continuation application of International Application No. PCT/CN2023/071175, filed Jan. 9, 2023, which claims priority to Chinese Patent Application No. 202210150924.4, filed on Feb. 18, 2022, the content of both of which is incorporated herein by reference in its entirety.

### TECHNICAL FIELD

This specification relates to the field of computer technologies, and in particular, to a data processing method and apparatus.

### BACKGROUND

Data is the most important means of production in many applications such as a risk prevention and control application. As privacy policies of obtaining data by an application in a terminal device become more strict, principles of “minimum and necessary” and “user authorization” need to be satisfied when the application collects the data. The risk prevention and control application aims to extract a risk feature of a black market by analyzing a behavior of the black market, so as to perform real-time risk prevention and control. However, there is low willingness to authorize data of the black market, and therefore, risk prevention and control is greatly affected.

### SUMMARY

A first aspect of this specification provides a data processing method, applied to a terminal device. The method includes: obtaining service data of a target service by using a trusted application corresponding to the target service, and transferring the service data to a trusted execution environment of the terminal device, where a privacy preserving rule for performing differential privacy processing on the service data of the target service is set in the trusted execution environment of the terminal device; performing differential privacy processing on the service data of the target service based on the privacy preserving rule in the trusted execution environment of the terminal device, to obtain differential privacy-based service data; and transferring the differential privacy-based service data to a trusted execution environment of a server, to trigger the server to obtain risk label information corresponding to the service data, and to determine risk information corresponding to the service data based on the risk label information and the differential privacy-based service data in the trusted execution environment of the server.

A second aspect of this specification provides a data processing method, applied to a server. The method includes: obtaining differential privacy-based service data from different terminal devices by using a trusted application corresponding to a target service, and transferring the differential privacy-based service data to a trusted execution environment of the server, where the differential privacy-based service data is obtained after a terminal device performs differential privacy processing on service data of the target service based on a privacy preserving rule in a trusted execution environment of the terminal device; obtaining risk label information corresponding to the service data of the target service by using the trusted application, and transferring the risk label information to the trusted execution environment of the server; and performing in the trusted execution environment of the server, based on the risk label information and the differential privacy-based service data, aggregation analysis processing on the differential privacy-based service data from the different terminal devices, to determine risk information corresponding to the service data of the target service.

A third aspect of this specification provides a data processing method, applied to a blockchain system. The method includes: obtaining risk detection rule information of service data of a target service, generating a corresponding first smart contract based on the risk detection rule information, and deploying the first smart contract in the blockchain system; based on the first smart contract, obtaining differential privacy-based service data from different terminal devices by using a trusted application corresponding to the target service, and transferring the differential privacy-based service data to a trusted execution environment of a server, where the differential privacy-based service data is obtained after the terminal device performs differential privacy processing on the service data of the target service based on a privacy preserving rule in a trusted execution environment of the terminal device; based on the first smart contract, obtaining risk label information corresponding to the service data of the target service by using the trusted application, and transferring the risk label information to the trusted execution environment of the server; and based on the first smart contract, performing in the trusted execution environment of the server, based on the risk label information and the differential privacy-based service data, aggregation analysis processing on the differential privacy-based service data from the different terminal devices, to determine risk information corresponding to the service data of the target service.

A fourth aspect of this specification provides a data processing apparatus, applied to a terminal device. The apparatus includes a processor; and a memory storing instructions executable by the processor. The processor is configured to perform the data processing method according to the first aspect.

A fifth aspect of this specification provides a data processing apparatus, applied to a server. The apparatus includes a processor; and a memory storing instructions executable by the processor. The processor is configured to perform the data processing method according to the second aspect.

A sixth aspect of this specification provides a non-transitory computer-readable storage medium storing instructions that, when executed by a processor, cause the processor to perform the data processing method according to the first aspect.

A seventh aspect of this specification provides a non-transitory computer-readable storage medium storing instructions that, when executed by a processor, cause the processor to perform the data processing method according to the second aspect.

### BRIEF DESCRIPTION OF DRAWINGS

FIG. 1 is a flowchart of a data processing method, according to an embodiment.

FIG. 2 is a schematic diagram illustrating a structure of an REE and a TEE, according to an embodiment.

FIG. 3 is a schematic diagram illustrating a structure of a data processing system, according to according to an embodiment.

FIG. 4 is a flowchart of a data processing method, according to an embodiment.

FIG. 5 shows some embodiments of still another data processing method, according to an embodiment.

FIG. 6 shows some embodiments of yet another data processing method, according to an embodiment.

FIG. 7A is a flowchart of a data processing method, according to an embodiment.

FIG. 7B is a schematic diagram of a data processing process, according to an embodiment.

FIG. 8 is a schematic diagram of a data processing apparatus, according to an embodiment.

FIG. 9 is a schematic diagram of a data processing apparatus, according to an embodiment.

FIG. 10 is a schematic diagram of a data processing apparatus, according to an embodiment.

FIG. 11 is a schematic diagram of a data processing apparatus, according to an embodiment.

### DESCRIPTION OF EMBODIMENTS

Reference will now be made in detail to embodiments, examples of which are illustrated in the accompanying drawings. The following description refers to the accompanying drawings in which the same numbers in different drawings represent the same or similar elements unless otherwise represented. The described embodiments are merely examples of rather than all the embodiments of the present disclosure.

Embodiments of the specification provide a cloud-end privacy data search solution based on a trusted execution environment. or information that is not authorized by a user, an application still cannot collect data, but may perform analysis in the trusted execution environment of the terminal device for risk prevention and control. For example, the application obtains only a final statistical result with risk discrimination, to ensure security of a calculation process and a calculation result.

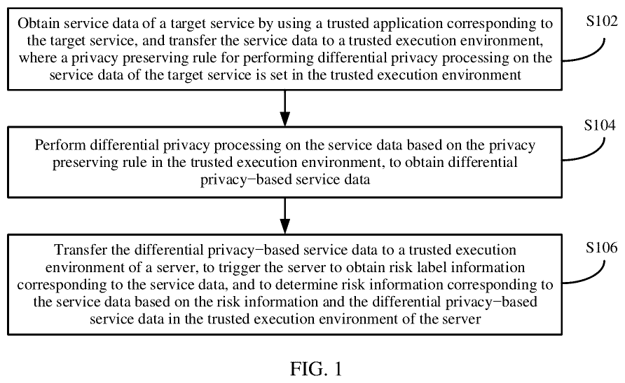

FIG. 1 is a flowchart of a data processing method according to an embodiment. The method can be performed by a terminal device. The terminal device can be a computer device such as a laptop computer or a desktop computer, or can be an IoT device, etc. A trusted execution environment, TEE, can be set in the terminal device. The trusted execution environment can be implemented by using a program written in a predetermined programming language (that is, can be implemented in a form of software), or can be jointly implemented by using a hardware device and a pre-written program (that is, can be implemented in a form of hardware and software). The trusted execution environment can be a secure running environment for performing data processing. The method can include the following steps.

Step S102: Obtain service data of a target service by using a trusted application corresponding to the target service, and transfer the service data to the trusted execution environment, where a privacy preserving rule for performing differential privacy processing on the service data of the target service is set in the trusted execution environment.

The target service can be any service, for example, a risk prevention and control service, a biological recognition service, or an information recommendation service, or an installation service of an application. Implementations can be specifically set based on an actual situation, and are not limited in embodiments of this specification.

The trusted application can be a pre-specified trusted application that can be used to process the service data, for example, a financial payment application, an instant messaging application, or a pre-developed application. The trusted application can be an application that needs to be installed in the terminal device, or can be a code program pre-installed in a hardware device of the terminal device, or can be a program that runs in the background and that is set in an operating system of the terminal device in a form of a plug-in, and can be specifically set based on an actual situation.

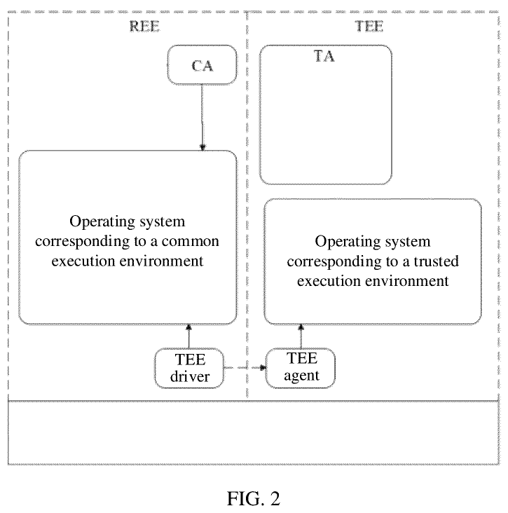

The trusted execution environment can be implemented by using a program written in a predetermined programming language (that is, can be implemented in a form of software). The trusted execution environment can be a secure data processing environment that is isolated from another environment. For example, processing performed in the trusted execution environment, data generated in a data processing process, etc. cannot be accessed by another execution environment or an application outside the trusted execution environment. FIG. 2 is a schematic diagram illustrating a structure of a rich execution environment (REE) and a trusted execution environment (TEE) according to an embodiment. As shown in FIG. 2, the trusted execution environment can be implemented by creating a small operating system that can run independently in a trusted zone (for example, TrustZone), and the trusted execution environment can directly provide a service through a system call (for example, direct processing by a TrustZone kernel). The terminal device can include the rich execution environment (REE) and the trusted execution environment (TEE). An operating system, for example, an Android operating system, an iOS operating system, a Windows operating system, or a Linux operating system, installed on the terminal device can run in the REE. The REE is characterized by robust functionality, openness, and good scalability, and can provide an upper-layer application with all functions such as a camera function and a touch function of the terminal device. However, potential security hazards may exist in the REE. For example, the operating system can obtain all data of an application, but it is difficult to verify whether the operating system or the application is tampered with. If the operating system or the application is tampered with, user information has a very large potential security hazard. In view of this, processing needs to be performed in the TEE of the terminal device. The TEE has execution space of the TEE. In other words, an operating system also exists in the TEE. The TEE has a higher security level than the REE. Software and hardware resources in the terminal device that can be accessed by the TEE are separated from those of the REE. Generally, the TEE can directly obtain information in the REE, and the REE cannot obtain information in the TEE. The TEE can perform processing such as verification through a provided interface, to ensure that the user information (for example, payment information and user privacy information) is not tampered with, no password is hijacked, and information such as fingerprint or facial information is not stolen.

The privacy preserving rule can be a rule that can be used to perform differential privacy processing on the service data. The privacy preserving rule can be set in a plurality of different manners, for example, can be set based on a rule of a predetermined differential privacy algorithm, and can be specifically set based on an actual situation. In addition, a verification rule is set in advance in the trusted execution environment of the terminal device. To ensure security of the privacy preserving rule, the privacy preserving rule can be a ciphertext. For example, for the privacy preserving rule, content of the privacy preserving rule can be formulated by an authorized rule maker. Then, the privacy preserving rule can be encrypted or signed in a specified encryption or signature manner, to form the ciphertext of the privacy preserving rule, and then the ciphertext of the privacy preserving rule is transferred to the trusted execution environment of the terminal device through a specified secure data transmission channel, to ensure security of the privacy preserving rule, and prevent the privacy preserving rule from being tampered with. In a trusted execution environment, decryption or signature verification can be performed on the ciphertext of the privacy preserving rule. After it is determined that the privacy preserving rule is not tampered with (for example, signature verification succeeds, or decryption can be performed and a decrypted privacy preserving rule satisfies a predetermined condition), the privacy preserving rule can be stored in the trusted execution environment.

The trusted application can be an application that performs the data processing and installed in the terminal device. A data processing entry can be set in the application. When the terminal device executes the target service, the service data of the target service can be obtained, and a subsequent data processing process can be executed based on the obtained service data. For example, a trusted application configured to perform data processing can be set, to protect privacy data in the terminal device, so as to ensure security in a data transmission process, and prevent privacy data in the service data from being obtained by any application in the REE. The service data is obtained by using the trusted application, and the service data is temporarily protected. For example, another application that is not authorized can be prevented from accessing the service data, to perform data protection; or predetermined processing can be performed on the service data, to obtain processed service data, so as to perform data protection. For example, the service data is encrypted or signed, to obtain encrypted or signed service data. When the terminal device executes the target service, the trusted application can be started. A secure interface can be set in advance in the trusted application. Correspondingly, a corresponding secure interface can also be set in the TEE of the terminal device, and a secure data transmission channel can be established between the trusted application and the TEE through a secure interface between the trusted application and the TEE. The trusted application can obtain the service data of the target service, and can transfer the service data to the TEE of the terminal device through the secure interface and the data transmission channel. Security of data in a transmission process can be ensured by setting the trusted application, the secure interface, the data transmission channel, etc.

There can be a plurality of trusted applications. The corresponding trusted application can be set based on a service type, a service identifier, etc. corresponding to the service data; or the corresponding trusted application can be set based on data content, a data type, etc. of the service data; or the corresponding trusted application can be set based on different users corresponding to the service data. Based on the above-mentioned cases, the service data can further include, for example, the service type, the service identifier, the data type, or use-related information. In some embodiments, how to set the trusted application can be set based on an actual situation. Implementations are not limited in embodiments of this specification.

Step S104: Perform differential privacy processing on the service data based on the privacy preserving rule in the trusted execution environment, to obtain differential privacy-based service data.

In an implementation, privacy preserving processing can be performed on the service data in the trusted execution environment (TEE), to ensure that the service data is not disclosed in a processing process. There can be a plurality of specific privacy preserving processing processes. The following provides an example of the processing manner. Specifically, the processing manner can include: The privacy preserving rule for performing differential privacy processing on the service data can be predetermined, and after the service data is transferred to the TEE of the terminal device, the service data can be placed in the trusted execution environment of the TEE. In the trusted execution environment (TEE), the terminal device can analyze the service data. For example, the terminal device can determine a service category corresponding to the service data, or determine organization or organization-related information corresponding to the service data. Then, the terminal device can obtain a corresponding privacy preserving rule based on the determined service category or the determined organization or organization-related information. In the trusted execution environment (TEE), differential privacy processing can be performed on the service data based on the obtained privacy preserving rule. Differential privacy processing can be performed on the service data in a plurality of manners. For example, random noise data can be predetermined. Then, the random noise data can be added to the service data in a specified processing manner. Finally, the differential privacy-based service data can be obtained. Because the processing performed in the trusted execution environment of the TEE is known to another execution environment of the terminal device or any application in the terminal device, the service data (in particular, the privacy data in the service data) in the trusted execution environment (TEE) is not obtained by any software or hardware device outside the trusted execution environment (TEE), to ensure accuracy and security of the service data (the service data is not tampered with or disclosed). In some embodiments, in addition to the above-mentioned manner, differential privacy processing can be performed in a plurality of other implementable manners. Details are omitted here for simplicity.

The above manner of performing differential privacy processing on the service data is only an implementable processing manner. In some embodiments, differential privacy processing can be performed on the service data in a plurality of other processing manners. Differential privacy processing can be performed on the service data in different processing manners based on different privacy preserving rules. In addition, a specific processing process of performing differential privacy processing on the service data can vary with the privacy preserving rule. Implementations can be specifically set based on an actual situation, and are not limited in embodiments of this specification.

Step S106: Transfer the differential privacy-based service data to a trusted execution environment of the server, to trigger the server to obtain risk label information corresponding to the service data, and determine risk information corresponding to the service data based on the risk label information and the differential privacy-based service data in the trusted execution environment of the server.

The risk label information can be information about a label used to record whether a risk exists.

In an implementation, after the differential privacy-based service data is determined in the trusted execution environment, the differential privacy-based service data can be obtained from the trusted execution environment of the terminal device by using the trusted application, and the differential privacy-based service data is transferred to the server. The trusted application corresponding to the target service in the server can obtain the differential privacy-based service data, and can transfer the differential privacy-based service data to the trusted execution environment of the server. In this case, the server can obtain the risk label information corresponding to the service data, and determine the risk information corresponding to the service data based on the risk information and the differential privacy-based service data in the trusted execution environment of the server. For details, references can be made to subsequent related content. Details are omitted here for simplicity.

In the above embodiments, the data processing method is applied to the terminal device. The terminal device includes the trusted execution environment. The service data of the target service is obtained by using the trusted application corresponding to the target service, and the service data is transferred to the trusted execution environment. The privacy preserving rule for performing differential privacy processing on the service data of the target service is set in the trusted execution environment. Differential privacy processing can be performed on the service data based on the privacy preserving rule in the trusted execution environment, to obtain the differential privacy-based service data; and the differential privacy-based service data can be transferred to the trusted execution environment of the server. Further, the server obtains the risk label information corresponding to the service data, and the risk information corresponding to the service data is determined based on the risk information and the differential privacy-based service data in the trusted execution environment of the server. In this way, a cloud-end privacy data search solution based on the trusted execution environment is provided in the above-mentioned manner, to perform analysis processing on information that is not authorized by a user, so as to ensure security of the calculation process, and ensure security of the calculation result. In addition, the trusted execution environment is a security zone established by software and hardware on a data calculation platform, to ensure that code and data loaded in the security zone are protected in terms of confidentiality and integrity and security is high.

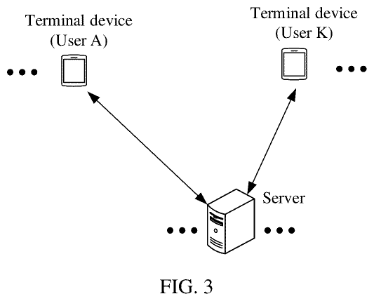

FIG. 3 is a schematic diagram illustrating a structure of a data processing system, according to according to an embodiment. The system can include a server and one or more terminal devices, e.g., corresponding to User A, . . . , and User K, respectively. Each of the one or more terminal devices can perform the data processing method illustrated in FIG. 1.

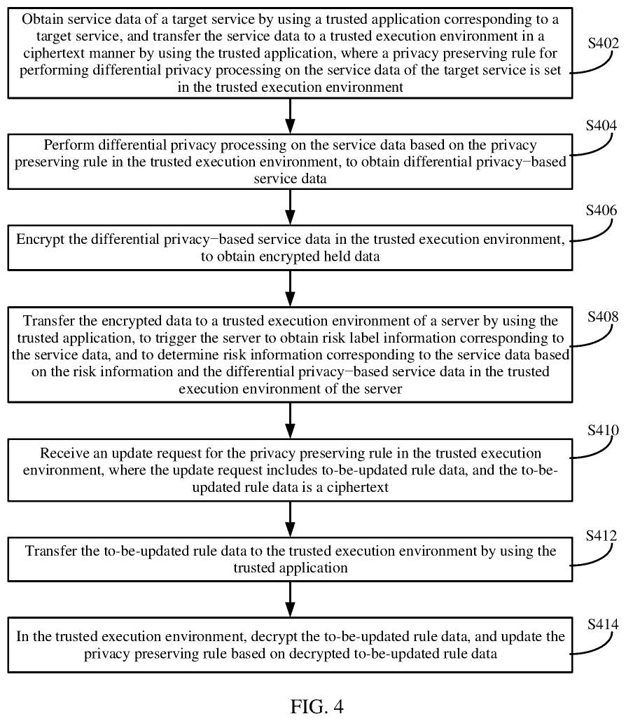

FIG. 4 is a flowchart of a data processing method, according to an embodiment. The method can be performed by a terminal device. The terminal device can be a computer device such as a laptop computer or a desktop computer, or can be an IoT device, etc. A trusted execution environment can be set in the terminal device. The trusted execution environment can be a trusted execution environment (TEE). The trusted execution environment can be implemented by using a program written in a predetermined programming language (that is, can be implemented in a form of software), or can be jointly implemented by using a hardware device and a pre-written program (that is, can be implemented in a form of hardware and software). The trusted execution environment can be a secure running environment for performing data processing. The method can include the following steps.

Step S402: Obtain service data of a target service by using a trusted application corresponding to a target service, and transfer the service data to the trusted execution environment in a ciphertext manner by using the trusted application, where a privacy preserving rule for performing differential privacy processing on the service data of the target service is set in the trusted execution environment.

In an implementation, service data can be encrypted, to ensure security of the service data in a data transmission process. There can be a plurality of used encryption algorithms such as a symmetric encryption algorithm or an asymmetric encryption algorithm. The trusted application can encrypt the service data based on the symmetric encryption algorithm or the asymmetric encryption algorithm, to obtain encrypted service data (in this case, the service data is a ciphertext). Then, the trusted application can transfer the encrypted service data to the trusted execution environment of the terminal device through a corresponding interface and data transmission channel, to ensure security of the service data in a transfer process.

In step S402, if the service data is encrypted, the service data can be no longer encrypted, or the service data can be encrypted again. This can be specifically set based on an actual situation.

In some embodiments, for the target service, an uploading probability of the service data of the target service can be predetermined. The uploading probability can represent a probability that the terminal device uploads real service data to a server. Correspondingly, if the uploading probability is p, a probability that the terminal device uploads false service data to the server is 1-p. Based on this, processing of transferring the service data to the trusted execution environment in step S402 can be performed in step A2 and step A4.

Step A2: Determine, based on the uploading probability corresponding to the service data, whether the service data needs to be uploaded to the server. The uploading probability can be set based on an actual situation, for example, 90% or 95%.

Step A4: Transfer the service data to the trusted execution environment if yes.

Step S404: Perform differential privacy processing on the service data based on the privacy preserving rule in the trusted execution environment, to obtain differential privacy-based service data.

The privacy preserving rule is set based on at least one of: a privacy preserving rule established based on a differential privacy algorithm of a Laplace mechanism; or a privacy preserving rule established based on a differential privacy algorithm of an exponential mechanism.

In an implementation, differential privacy aims to protect collected data to a certain extent although corresponding data is still uploaded to a data collection party subsequently when a user whose data is collected does not trust the data collection party or does not authorize the data collection party to collect related data. Differential privacy can maximize data query accuracy when a statistical database is queried and reduce, to a maximum extent, a probability of identifying a record in the statistical database. The differential privacy aims to preserve privacy by perturbing data. There can be a plurality of perturbation mechanisms such as the Laplace mechanism or the exponential mechanism. The differential privacy can include central differential privacy and local differential privacy (LDP). For the local differential privacy, before the service data is collected, a user locally perturbs the service data, and then uploads, to a service center, service data to which noise is added. The local differential privacy can be defined as follows: An algorithm A is local differential privacy (E-LDP) satisfied by E, where €>0, when and only when for any two pieces of data v and v′, the following formula is satisfied:

$$- ϵ \leq ln ( \frac{Pr ( A ( v ) = y )}{Pr ( A ( {v}^{′} ) = y )} ) \leq ϵ$$

Here, v and v′ belong to a domain of definition of A, and y belongs to a value domain of A. From a perspective of the user, the local differential privacy can better protect privacy data in the service data. Before the service data is collected, perturbation processing is locally performed on the service data, and the privacy data in the service data is erased. The differential privacy in some embodiments of this specification can be the local differential privacy.

In the embodiments of this specification, in the trusted execution environment, differential privacy processing is performed on the service data based on the privacy preserving rule, and the privacy data in the service data in a data uploading process is protected. For example, to prevent the service data from being disclosed, differential privacy processing can be performed on the service data, so that the service data is perturbed. Even if the service data is disclosed, the service data cannot be identified, so that the service data is known to another person, and the privacy data in the service data is protected. There can be a plurality of implementable manners of the differential privacy. An example of the implementation manner is provided below, and can include: performing differential privacy processing on the service data based on the differential privacy algorithm of the exponential mechanism, to obtain the differential privacy-based service data. Specifically, for the differential privacy algorithm of the exponential mechanism, if an output domain of a query function is R, and each output value in the output domain is r, where rER, a function q (D, r)→R becomes a function of availability of the output value r, and is used to evaluate a quality of the output value r. If an input of a random algorithm M is a data set D, and an output is an object r, where rER, the function q (D, r)→R is the function of availability, and Aq is sensitivity of the function q (D, r)→R. If the algorithm M selects and outputs r from R in a probability proportional to exp (eq (D, r)/2Δq), the algorithm M provides e-differential privacy preserving. Based on the above manner, if the input of the algorithm M is the service data, and the output value corresponding to the service data is r, where rER, the algorithm M selects and outputs r from R in the probability proportional to exp (eq (service data, r)/2Δq), to obtain the differential privacy-based service data.

The above processing process is merely an implementable manner of differential privacy. In some embodiments, in addition to the above manner, differential privacy processing can be performed on the service data in a plurality of manners. Implementations can be specifically set based on an actual situation, and are not limited in embodiments of this specification.

Step S406: Encrypt the differential privacy-based service data in the trusted execution environment, to obtain encrypted data.

In an implementation, to ensure security of the differential privacy-based service data in the data transmission process, the differential privacy-based service data can be encrypted in the trusted execution environment. There can be a plurality of used encryption algorithms such as a symmetric encryption algorithm or an asymmetric encryption algorithm. The trusted application can encrypt the differential privacy-based service data based on the symmetric encryption algorithm or the asymmetric encryption algorithm, to obtain the encrypted data (in this case, the differential privacy-based service data is a ciphertext), to ensure security of the differential privacy-based service data in a subsequent transfer process.

In step S406, if the differential privacy-based service data is encrypted, there can be no need to encrypt the differential privacy-based service data, or the differential privacy-based service data can be encrypted again. This can be specifically set based on an actual situation.

Step S408: Transfer the encrypted data to a trusted execution environment of the server by using the trusted application, to trigger the server to obtain risk label information corresponding to the service data, and determine risk information corresponding to the service data based on the risk label information and the differential privacy-based service data in the trusted execution environment of the server.

Step S410: Receive an update request for the privacy preserving rule in the trusted execution environment, where the update request includes to-be-updated rule data, and the to-be-updated rule data is a ciphertext.

In an implementation, the privacy preserving rule can include a plurality of different types of content. In some embodiments, a model that is configured to perform differential privacy processing on the service data can be set in the trusted execution environment (TEE) based on an actual situation, for example, a classification model. The model can be obtained by using a relatively complex program written in a predetermined programming language, or can be obtained based on a relatively simple algorithm. Implementations are not limited in embodiments of this specification. In addition, to prevent an unrelated user from updating the privacy preserving rule, related information of a user with update permission (for example, a user who initially sets or creates the privacy preserving rule or a pre-specified user) can be set for the privacy preserving rule. In other words, only the user with the update permission can update the privacy preserving rule. When a privacy preserving rule in the TEE needs to be updated, the user can enter, by using a trusted application in a terminal device of the user, an identifier of a privacy preserving rule that needs to be modified and to-be-updated rule data. After such an input is completed, the terminal device can obtain the identifier of the privacy preserving rule that needs to be updated and the to-be-updated rule data that are entered, and can generate an update request, so that the terminal device can obtain the update request for the privacy preserving rule.

The to-be-updated rule data can be a model, an algorithm, etc. in the privacy preserving rule, or can be a service type to which the privacy preserving rule is applicable, etc. Implementations can be specifically set based on an actual situation, and are not limited in embodiments of this specification.

Step S412: Transfer the to-be-updated rule data to the trusted execution environment by using the trusted application.

Step S414: In the trusted execution environment, decrypt the to-be-updated rule data, and update the privacy preserving rule based on decrypted to-be-updated rule data.

In an implementation, after obtaining the update request for the privacy preserving rule, the terminal device can obtain an identifier of the privacy preserving rule, which is included in the update request, and can find the corresponding privacy preserving rule based on the identifier. Information about a user with update permission for the privacy preserving rule can be obtained, and whether the obtained information about the user with the update permission includes information about a current user who initiates the update request can be found in the obtained information about the user with the update permission. If the obtained information about the user with the update permission includes the information about the current user who initiates the update request can be found in the obtained information about the user with the update permission, it can be determined that the current user who initiates the update request has the update permission for the privacy preserving rule. In this case, the terminal device can update the privacy preserving rule in the trusted execution environment (TEE) based on the update request, to obtain the updated privacy preserving rule. If the obtained information about the user with the update permission includes the information about the current user who initiates the update request can be found in the obtained information about the user with the update permission, it can be determined that the current user who initiates the update request does not have the update permission for the privacy preserving rule. In this case, the terminal device can send an update failure notification message to the current user who initiates the update request.

In the above embodiments, after the updated privacy preserving rule is obtained in the above manner, differential privacy processing can be subsequently performed on the service data based on the updated privacy preserving rule. In other words, processing in step S402 to step S408 can be subsequently performed. Processing in step S410 to step S414 can alternatively be performed before step S402 to step S408. Implementations are not limited in embodiments of this specification.

In the above embodiments, the data processing method is applied to the terminal device. The terminal device includes the trusted execution environment. The service data of the target service is obtained by using the trusted application corresponding to the target service, and the service data is transferred to the trusted execution environment. The privacy preserving rule for performing differential privacy processing on the service data of the target service is set in the trusted execution environment. Differential privacy processing can be performed on the service data based on the privacy preserving rule in the trusted execution environment, to obtain the differential privacy-based service data; and the differential privacy-based service data can be transferred to the trusted execution environment of the server. Further, the server obtains the risk label information corresponding to the service data, and the risk information corresponding to the service data is determined based on the risk information and the differential privacy-based service data in the trusted execution environment of the server. In this way, a cloud-end privacy data search solution based on the trusted execution environment is provided in the above-mentioned manner, to perform analysis processing on information that is not authorized by a user, so as to ensure security of the calculation process, and ensure security of the calculation result. In addition, the trusted execution environment is a security zone established by software and hardware on a data calculation platform, to ensure that code and data loaded in the security zone are protected in terms of confidentiality and integrity and security is high.

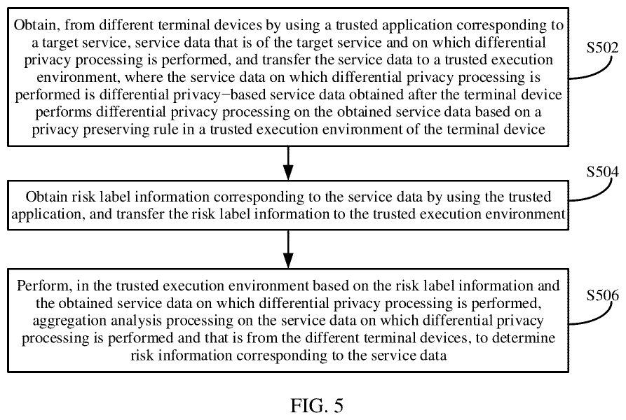

FIG. 5 is a flowchart of a data processing method, according to an embodiment. The method can be performed by a server. The server can be a server of a specific service (for example, a transaction service or a financial service). For example, the server can be a server of a payment service, or can be a server of a service related to finance, instant messaging, etc. A trusted execution environment (TEE) can be set in the server. The trusted execution environment can be implemented by using a program written in a predetermined programming language (that is, can be implemented in a form of software), or can be jointly implemented by using a hardware device and a pre-written program (that is, can be implemented in a form of hardware and software). The trusted execution environment can be a secure running environment for performing data processing. The method can include the following steps.

Step S502: Obtain, from different terminal devices by using a trusted application corresponding to a target service, service data that is of the target service and on which differential privacy processing is performed, and transfer the service data to the trusted execution environment, where the service data on which differential privacy processing is performed is differential privacy-based service data obtained after the terminal device performs differential privacy processing on the obtained service data based on a privacy preserving rule in a trusted execution environment of the terminal device.

A trusted application in the server can be an application different from a trusted application in the terminal device. The trusted application in the server can run in a program running environment of the server. The trusted application in the terminal device needs to run in a program running environment of the terminal device. The two trusted applications can be both for the same service, namely, the target service.

In an implementation, to ensure security in a data transmission process, an application (namely, the trusted application) that performs the above-mentioned data processing can be installed in the terminal device. The trusted application can be used to obtain, from the different terminal devices, the service data that is of the target service and on which differential privacy processing is performed (namely, the differential privacy-based service data), and temporarily protect the differential privacy-based service data. For example, another unauthorized application can be prevented from accessing the differential privacy-based service data, to perform data protection, or predetermined processing can be performed on the differential privacy-based service data, to obtain processed data, so as to perform data protection. For example, the differential privacy-based service data is encrypted or signed, to obtain encrypted or signed data. Also for example, a secure interface can be set in advance in the trusted application. Correspondingly, a corresponding secure interface can also be set in the TEE of the terminal device, and a secure data transmission channel can be established between the trusted application and the TEE through a secure interface between the trusted application and the TEE. The trusted application can obtain the differential privacy-based service data, and can transfer the differential privacy-based service data to the TEE of the terminal device through the secure interface and the data transmission channel. Security of data in the transmission process can be ensured by setting the trusted application, the secure interface, the data transmission channel, etc.

There can be a plurality of trusted applications. The corresponding trusted application can be set based on a service type, a service identifier, etc. corresponding to the service data; or the corresponding trusted application can be set based on data content, a data type, etc. of the service data; or the corresponding trusted application can be set based on different users corresponding to the service data. Based on the above-mentioned cases, the service data can further include, for example, the service type, the service identifier, the data type, or use-related information. In some embodiments, how to set the trusted application can be set based on an actual situation. Implementations are not limited in embodiments of this specification.

Step S504: Obtain risk label information corresponding to the service data by using the trusted application, and transfer the risk label information to the trusted execution environment.

The trusted execution environment can be a secure data processing environment that is isolated from another environment. For example, processing performed in the trusted execution environment, data generated in a data processing process, etc. cannot be accessed by another execution environment or an application outside an executable environment. For details, references can be made to the above content of the trusted execution environment. Details are omitted here for simplicity.

Step S506: Perform, in the trusted execution environment based on the risk label information and the obtained service data on which differential privacy processing (i.e., the differential privacy-based service data) is performed, aggregation analysis processing on the service data on which differential privacy processing is performed and that is from the different terminal devices, to determine risk information corresponding to the service data.

In an implementation, in the trusted execution environment, aggregation analysis processing can be performed on the service data on which differential privacy processing is performed and that is from the different terminal devices. In addition, specific service data that is at risk and specific service data that is not at risk can be finally determined with reference to the risk label information, to obtain risk information corresponding to each of the above-mentioned pieces of service data. For example, a risk detection model for the target service can be predetermined. The risk detection model can be established based on different algorithms, for example, can be established by using a neural network model, or can be established by using a decision tree model. Implementations can be specifically set based on an actual situation, and are not limited in embodiments of this specification. After the risk detection model is established in the above manner, a corresponding training sample can be obtained, and the risk detection model can be trained based on the obtained training sample, to obtain the trained risk detection model. The risk detection model can be set in the trusted execution environment of the server. After the service data on which differential privacy processing is performed is obtained in the trusted execution environment, the service data on which differential privacy processing is performed can be input into the risk detection model, to obtain first risk information corresponding to the service data. Then, the first risk information corresponding to the service data can be combined with the risk label information of the service data, to finally determine the risk information corresponding to the service data. In some embodiments, a federated learning process can also be performed in a plurality of different manners. For example, the server can split a target model, and then send a sub-model obtained through splitting to a corresponding terminal device.

In the above data processing method, the service data of the target service is obtained by using the trusted application corresponding to the target service, and the service data is transferred to the trusted execution environment. The privacy preserving rule for performing differential privacy processing on the service data of the target service is set in the trusted execution environment. Differential privacy processing can be performed on the service data based on the privacy preserving rule in the trusted execution environment, to obtain the differential privacy-based service data; and the differential privacy-based service data can be transferred to the trusted execution environment of the server. Further, the server obtains the risk label information corresponding to the service data, and the risk information corresponding to the service data is determined based on the risk information and the differential privacy-based service data in the trusted execution environment of the server. In this way, a cloud-end privacy data search solution based on the trusted execution environment is provided in the above manner, to perform analysis processing on information that is not authorized by a user, so as to ensure security of the calculation process, and ensure security of the calculation result. In addition, the trusted execution environment is a security zone established by software and hardware on a data calculation platform, to ensure that code and data loaded in the security zone are protected in terms of confidentiality and integrity and security is high.

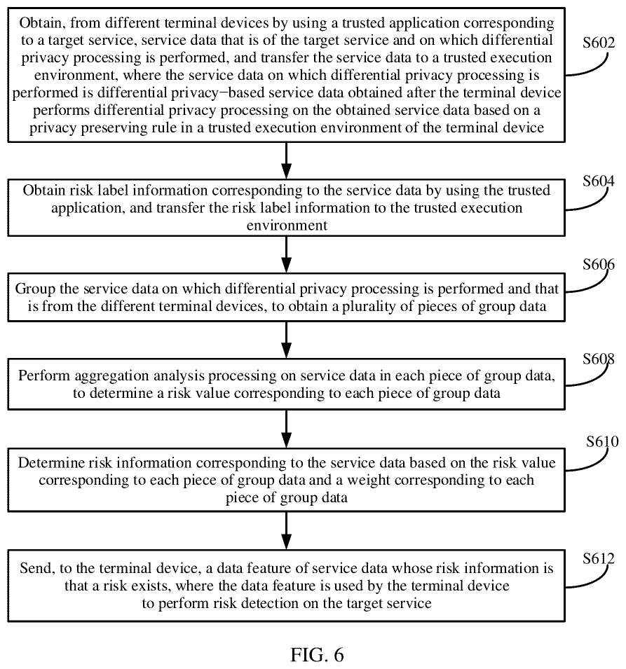

FIG. 6 is a flowchart of a data processing method, according to an embodiment. The method can be performed by a server. The server can be a server of a specific service (for example, a transaction service or a financial service). For example, the server can be a server of a payment service, or can be a server of a service related to finance, instant messaging, etc. A trusted execution environment (TEE) can be set in the server. The trusted execution environment can be implemented by using a program written in a predetermined programming language (that is, can be implemented in a form of software), or can be jointly implemented by using a hardware device and a pre-written program (that is, can be implemented in a form of hardware and software). The trusted execution environment can be a secure running environment for performing data processing. The method can include the following steps.

Step S602: Obtain, from different terminal devices by using a trusted application corresponding to a target service, service data that is of the target service and on which differential privacy processing is performed, and transfer the service data to the trusted execution environment, where the service data on which differential privacy processing is performed is differential privacy-based service data obtained after the terminal device performs differential privacy processing on the obtained service data based on a privacy preserving rule in a trusted execution environment of the terminal device.

Step S604: Obtain risk label information corresponding to the service data by using the trusted application, and transfer the risk label information to the trusted execution environment.

Step S606: Group the service data on which differential privacy processing is performed and that is from the different terminal devices, to obtain a plurality of pieces of group data.

In an implementation, to accelerate a data processing speed, improve data processing efficiency, and reduce data processing pressure of the server, the service data on which differential privacy processing is performed (i.e., the differential privacy-based service data) can be grouped. There can be a plurality of grouping manners such as random grouping or grouping based on a data type (for example, a login type, a service identifier type, or a service information type). The grouping manner can be specifically set based on an actual situation. In this way, the plurality of pieces of group data can be obtained.

In some embodiments, the service data can be grouped in a plurality of manners. An example of the processing manner is provided below, and can include: grouping, in an equal-width or equal-frequency manner, the service data on which differential privacy processing is performed and that is from the different terminal devices, to obtain the plurality of pieces of group data.

In an implementation, time-domain or frequency-domain analysis can be performed on the service data on which differential privacy processing is performed and that is from the different terminal devices, to determine duration of a data group or a frequency band size of a data group. Then, the service data on which differential privacy processing is performed and that is from the different terminal devices can be grouped based on the determined duration or frequency band size, to obtain the plurality of pieces of group data.

Step S608: Perform aggregation analysis processing on service data in each piece of group data, to determine a risk value corresponding to each piece of group data.

In an implementation, aggregation analysis processing is performed on the service data in each piece of group data, and determining the risk value corresponding to each piece of group data can be processed in a plurality of manners. For example, the risk value corresponding to each piece of group data can be determined by using the risk detection model described above.

In some embodiments, the risk value corresponding to each piece of group data can be further calculated based on the following formula:

$${IV}_{i} = ( {P}_{yi} - {P}_{ni} ) * {WOE}_{i} = ( {P}_{yi} - {P}_{ni} ) * ln \frac{{P}_{yi}}{{P}_{ni}} = ( {y}_{i} / {y}_{s} - {n}_{i} / {n}_{s} ) * ln \frac{{y}_{i} / {y}_{s}}{{n}_{i} / {n}_{s}}$$

Here, i represents the i^{th} group data, IVᵢ represents a risk value corresponding to the i^{th} group data, P_{yi} represents a proportion of a positive sample in the i^{th} group data in all positive samples, Pₙᵢ represents a proportion of a negative sample in the i^{th} group data in all negative samples, WOE; represents a value of a weight of evidence (WOE) in the i^{th} group data, yᵢ represents a quantity of positive samples in the i^{th} group data, yₛ represents a quantity of all positive samples, ni represents a quantity of negative samples in the i^{th} group data, and nₛ represents a quantity of all negative samples.

Step S610: Determine risk information corresponding to the service data based on the risk value corresponding to each piece of group data and a weight corresponding to each piece of group data.

In an implementation, the corresponding weight can be set in advance for each piece of group data, and then, weighted summation can be performed on risk values corresponding to the plurality of pieces of group data based on the risk value corresponding to each piece of group data and the weight corresponding to each piece of group data. An obtained result can be used as a risk value corresponding to the service data, by using the following formula:

$$IV = {\sum }_{i}^{n} {IV}_{i}$$

Here, IV represents the risk value corresponding to the service data. The risk information corresponding to the service data can be determined based on the obtained risk value. For example, if the obtained risk value is greater than a predetermined threshold, it can be determined that the risk information corresponding to the service data is that a risk exists; or if the obtained risk value is not greater than a predetermined threshold, it can be determined that the risk information corresponding to the service data is that no risk exists.

Step S612: Send, to the terminal device, a data feature of service data whose risk information is that a risk exists, where the data feature is used by the terminal device to perform risk detection on the target service.

In the above data processing method, the service data of the target service is obtained by using the trusted application corresponding to the target service, and the service data is transferred to the trusted execution environment. The privacy preserving rule for performing differential privacy processing on the service data of the target service is set in the trusted execution environment. Differential privacy processing can be performed on the service data based on the privacy preserving rule in the trusted execution environment, to obtain the differential privacy-based service data; and the differential privacy-based service data can be transferred to the trusted execution environment of the server. Further, the server obtains the risk label information corresponding to the service data, and the risk information corresponding to the service data is determined based on the risk information and the differential privacy-based service data in the trusted execution environment of the server. In this way, a cloud-end privacy data search solution based on the trusted execution environment is provided in the above-mentioned manner, to perform analysis processing on information that is not authorized by a user, so as to ensure security of the calculation process, and ensure security of the calculation result. In addition, the trusted execution environment is a security zone established by software and hardware on a data calculation platform, to ensure that code and data loaded in the security zone are protected in terms of confidentiality and integrity and security is high.

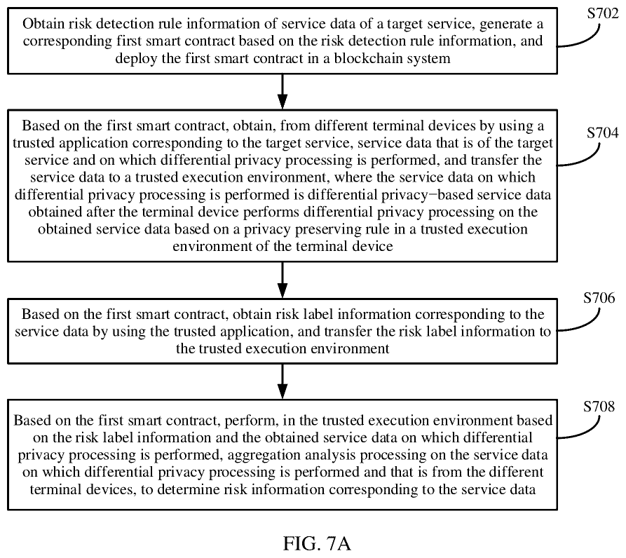

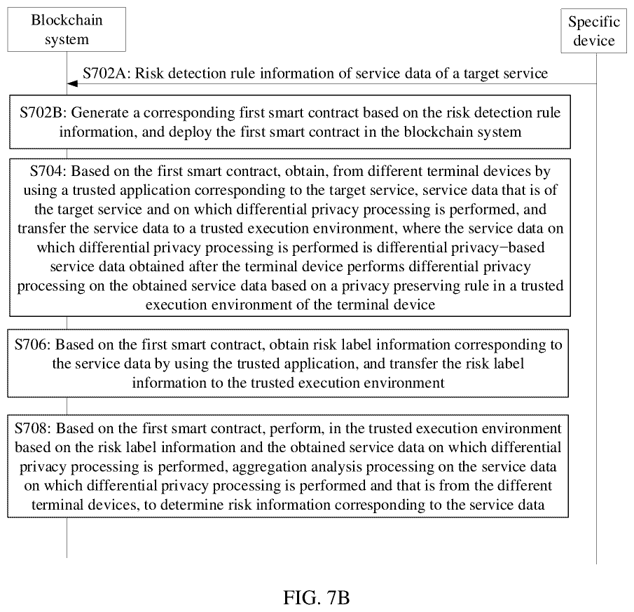

FIG. 7A is a flowchart of a data processing method, according an embodiment. FIG. 7B is a schematic diagram of a corresponding data processing process, according an embodiment. The method can be performed by a blockchain system. The blockchain system can include a terminal device, a server, etc. The terminal device can be a mobile terminal device such as a mobile phone or a tablet computer, or can be a device such as a personal computer. The server can be an independent server, or can be a server cluster including a plurality of servers. The server can be a background server of a financial service, a network shopping service, etc., or can be a background server of a specific application. The method can be applied to a related scenario of data processing, etc. The method can include the following steps.

Step S702: Obtain risk detection rule information of service data of a target service, generate a corresponding first smart contract based on the risk detection rule information, and deploy the first smart contract in the blockchain system.

For example, in the process shown in FIG. 7B, Step S702 is performed in two steps: S702A: Send risk detection rule information of service data of a target service to the blockchain system from a specific device, and S702B: Generate a corresponding first smart contract based on the risk detection rule information, and deploy the first smart contract in the blockchain system.

The first smart contract can be a computer agreement that aims to disseminate, verify, or execute a contract in an informationization manner. The first smart contract allows trusted interaction without a third party. The interaction process is traceable and irreversible due to the use of the blockchain system. The first smart contract includes an agreement in which a contract participant can fulfill right and obligation agreed upon by a contract party.

In an implementation, to make traceability of a risk detection process based on the service data of the target service better, a specified blockchain system can be created or added. In this way, risk detection can be performed on the service data of the target service based on the blockchain system. For example, a corresponding application can be installed in a blockchain node. An input box, a select box, etc. in which there is the risk detection rule information of the service data of the target service can be set in the application, and corresponding information can be set in the input box and/or the select box. Then, the blockchain system can receive the risk detection rule information of the service data of the target service. The blockchain system can generate the corresponding first smart contract based on the risk detection rule information of the service data of the target service, and can deploy the first smart contract in the blockchain system. In this way, the blockchain system stores the risk detection rule information of the service data of the target service and the corresponding first smart contract. Another user cannot tamper with the risk detection rule information of the service data of the target service and the corresponding first smart contract. In addition, the blockchain system performs risk detection on the service data based on the first smart contract.

Step S704: Based on the first smart contract, obtain, from different terminal devices by using a trusted application corresponding to the target service, service data that is of the target service and on which differential privacy processing is performed, and transfer the service data to a trusted execution environment, where the service data on which differential privacy processing is performed is differential privacy-based service data obtained after the terminal device performs differential privacy processing on the obtained service data based on a privacy preserving rule in a trusted execution environment of the terminal device.

In an implementation, related rule information that the service data that is of the target service and on which differential privacy processing is performed is obtained from the different terminal devices by using the trusted application corresponding to the target service and the service data is transferred to the trusted execution environment, can be set in the first smart contract. In this way, the corresponding processing can be implemented based on the rule information in the first smart contract. For details, references can be made to the above related content.

Step S706: Based on the first smart contract, obtain risk label information corresponding to the service data by using the trusted application, and transfer the risk label information to the trusted execution environment.

In an implementation, related rule information that the risk label information corresponding to the service data is obtained by using the trusted application and the risk label information is transferred to the trusted execution environment can be set in the first smart contract. In this way, the above-mentioned corresponding processing, can be implemented based on the rule information in the first smart contract. For details, references can be made to the above related content.

Step S708: Based on the first smart contract, perform, in the trusted execution environment based on the risk label information and the obtained service data on which differential privacy processing is performed, aggregation analysis processing on the service data on which differential privacy processing is performed and that is from the different terminal devices, to determine risk information corresponding to the service data.

In an implementation, related rule information that aggregation analysis processing is performed, in the trusted execution environment based on the risk label information and the obtained service data on which differential privacy processing is performed, on the service data on which differential privacy processing is performed and that is from the different terminal devices can be set in the first smart contract. In this way, the corresponding processing can be implemented based on the rule information in the first smart contract. For details, references can be made to the above related content.

After the above processing, the blockchain system can further perform the following processing: sending, to the terminal device based on a second smart contract pre-deployed in the blockchain system, a data feature of service data whose risk information is that a risk exists, where the data feature is used by the terminal device to perform risk detection on the target service.

In an implementation, related rule information that the data feature of the service data whose risk information is that a risk exists is sent to the terminal device can be set in the second smart contract. In this way, the corresponding processing can be implemented based on the rule information in the second smart contract. For details, references can be made to the above related content.

For specific processing in step S704 to step S708, references can be made to the description above in connection with FIG. 5 and FIG. 6. In other words, various processing related to the embodiments in connection with FIG. 5 and FIG. 6 can be implemented by using a corresponding smart contract.

Embodiments of this specification provide the data processing method applied to the blockchain system. The service data of the target service is obtained by using the trusted application corresponding to the target service, and the service data is transferred to the trusted execution environment. The privacy preserving rule for performing differential privacy processing on the service data of the target service is set in the trusted execution environment. Differential privacy processing can be performed on the service data based on the privacy preserving rule in the trusted execution environment, to obtain the differential privacy-based service data; and the differential privacy-based service data can be transferred to the trusted execution environment of the blockchain system. Further, the blockchain system obtains the risk label information corresponding to the service data, and the risk information corresponding to the service data is determined based on the risk information and the differential privacy-based service data in the trusted execution environment of the blockchain system. In this way, a cloud-end privacy data search solution based on the trusted execution environment is provided in the above-mentioned manner, to perform analysis processing on information that is not authorized by a user, so as to ensure security of the calculation process, and ensure security of the calculation result. In addition, the trusted execution environment is a security zone established by software and hardware on a data calculation platform, to ensure that code and data loaded in the security zone are protected in terms of confidentiality and integrity and security is high.

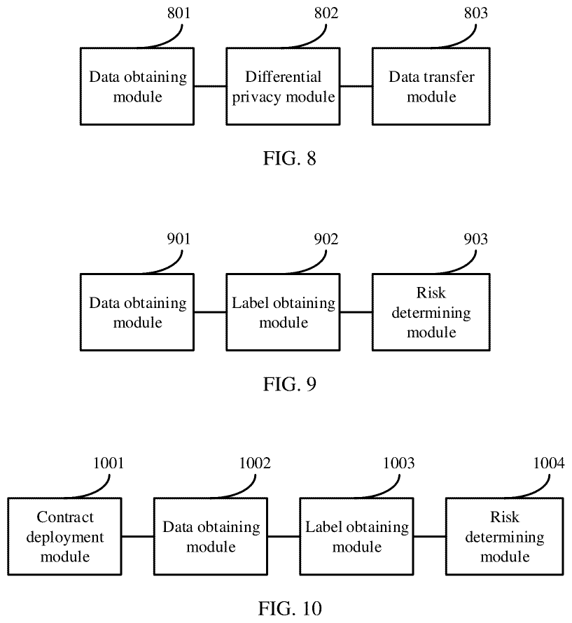

FIG. 8 is a schematic diagram of a data processing apparatus, according to an embodiment. The apparatus includes a trusted execution environment.

The data processing apparatus includes a data obtaining module 801, a differential privacy module 802, and a data transfer module 803. The data obtaining module 801 is configured to: obtain service data of a target service by using a trusted application corresponding to the target service, and transfer the service data to the trusted execution environment, where a privacy preserving rule for performing differential privacy processing on the service data of the target service is set in the trusted execution environment. The differential privacy module 802 is configured to perform differential privacy processing on the service data based on the privacy preserving rule in the trusted execution environment, to obtain differential privacy-based service data. The data transfer module 803 is configured to: transfer the differential privacy-based service data to a trusted execution environment of a server, to trigger the server to obtain risk label information corresponding to the service data, and determine risk information corresponding to the service data based on the risk information and the differential privacy-based service data in the trusted execution environment of the server.

In some embodiments, the data obtaining module 801 is configured to: obtain the service data of the target service by using the trusted application corresponding to the target service, and transfer the service data to the trusted execution environment in a ciphertext manner by using the trusted application.

In some embodiments, the apparatus further includes: an update request module (not shown), configured to receive an update request for the privacy preserving rule in the trusted execution environment, where the update request includes to-be-updated rule data, and the to-be-updated rule data is a ciphertext; a rule transfer module, configured to transfer the to-be-updated rule data to the trusted execution environment by using the trusted application; and an update module, configured to: in the trusted execution environment, decrypt the to-be-updated rule data, and update the privacy preserving rule based on decrypted to-be-updated rule data.

In some embodiments, the privacy preserving rule is set based on at least one of: a privacy preserving rule established based on a differential privacy algorithm of a Laplace mechanism; or a privacy preserving rule established based on a differential privacy algorithm of an exponential mechanism.

In some embodiments, the data obtaining module 801 includes: an encryption unit, configured to encrypt the differential privacy-based service data in the trusted execution environment, to obtain encrypted data; and a first data transfer unit, configured to transfer the encrypted data to the trusted execution environment of the server by using the trusted application.

In some embodiments, an uploading probability is set for the service data, and the data obtaining module 801 includes: a determining unit, configured to determine, based on the uploading probability corresponding to the service data, whether the service data needs to be uploaded to the server; and a second data transfer unit, configured to transfer the service data to the trusted execution environment if yes.

In the embodiments, the data processing apparatus includes a trusted execution environment. The service data of the target service is obtained by using the trusted application corresponding to the target service, and the service data is transferred to the trusted execution environment. The privacy preserving rule for performing differential privacy processing on the service data of the target service is set in the trusted execution environment. Differential privacy processing can be performed on the service data based on the privacy preserving rule in the trusted execution environment, to obtain the differential privacy-based service data; and the differential privacy-based service data can be transferred to the trusted execution environment of the server. Further, the server obtains the risk label information corresponding to the service data, and the risk information corresponding to the service data is determined based on the risk information and the differential privacy-based service data in the trusted execution environment of the server. In this way, a cloud-end privacy data search solution based on the trusted execution environment is provided in the above-mentioned manner, to perform analysis processing on information that is not authorized by a user, so as to ensure security of the calculation process, and ensure security of the calculation result. In addition, the trusted execution environment is a security zone established by software and hardware on a data calculation platform, to ensure that code and data loaded in the security zone are protected in terms of confidentiality and integrity and security is high.

FIG. 9 is a schematic diagram of a data processing apparatus, according to an embodiment. The apparatus includes a trusted execution environment.

The data processing apparatus includes a data obtaining module 901, a label obtaining module 902, and a risk determining module 903. The data obtaining module 901 is configured to: obtain, from different terminal devices by using a trusted application corresponding to a target service, service data that is of the target service and on which differential privacy processing is performed, and transfer the service data to the trusted execution environment, where the service data on which differential privacy processing is performed is differential privacy-based service data obtained after the terminal device performs differential privacy processing on the obtained service data based on a privacy preserving rule in a trusted execution environment of the terminal device. The label obtaining module 902 is configured to: obtain risk label information corresponding to the service data by using the trusted application, and transfer the risk label information to the trusted execution environment. The risk determining module 903 is configured to perform, in the trusted execution environment based on the risk label information and the obtained service data on which differential privacy processing is performed, aggregation analysis processing on the service data on which differential privacy processing is performed and that is from the different terminal devices, to determine risk information corresponding to the service data.

In some embodiments, the risk determining module 903 includes: a grouping unit, configured to group the service data on which differential privacy processing is performed and that is from the different terminal devices, to obtain a plurality of pieces of group data; an aggregation analysis unit, configured to perform aggregation analysis processing on service data in each piece of group data, to determine a risk value corresponding to each piece of group data; and a risk determining unit, configured to determine the risk information corresponding to the service data based on the risk value corresponding to each piece of group data and a weight corresponding to each piece of group data.

In some embodiments, the grouping unit groups, in an equal-width or equal-frequency manner, the service data on which differential privacy processing is performed and that is from the different terminal devices, to obtain the plurality of pieces of group data.

In some embodiments, the apparatus further includes: a feature sending module (not shown), configured to send, to the terminal device, a data feature of service data whose risk information is that a risk exists, where the data feature is used by the terminal device to perform risk detection on the target service.

In the embodiments, the data processing apparatus includes a trusted execution environment. The service data of the target service is obtained by using the trusted application corresponding to the target service, and the service data is transferred to the trusted execution environment. The privacy preserving rule for performing differential privacy processing on the service data of the target service is set in the trusted execution environment. Differential privacy processing can be performed on the service data based on the privacy preserving rule in the trusted execution environment, to obtain the differential privacy-based service data; and the differential privacy-based service data can be transferred to the trusted execution environment of the server. Further, the server obtains the risk label information corresponding to the service data, and the risk information corresponding to the service data is determined based on the risk information and the differential privacy-based service data in the trusted execution environment of the server. In this way, a cloud-end privacy data search solution based on the trusted execution environment is provided in the above-mentioned manner, to perform analysis processing on information that is not authorized by a user, so as to ensure security of the calculation process, and ensure security of the calculation result. In addition, the trusted execution environment is a security zone established by software and hardware on a data calculation platform, to ensure that code and data loaded in the security zone are protected in terms of confidentiality and integrity and security is high.

FIG. 10 is a schematic diagram of a data processing apparatus, according to an embodiment. The apparatus is an apparatus in a blockchain system, and includes a trusted execution environment.

The data processing apparatus includes a contract deployment module 1001, a data obtaining module 1002, a label obtaining module 1003, and a risk determining module 1004. The contract deployment module 1001 is configured to: obtain risk detection rule information of service data of a target service, generate a corresponding first smart contract based on the risk detection rule information, and deploy the first smart contract in the blockchain system. The data obtaining module 1002 is configured to: based on the first smart contract, obtain, from different terminal devices by using a trusted application corresponding to the target service, service data that is of the target service and on which differential privacy processing is performed, and transfer the service data to the trusted execution environment, where the service data on which differential privacy processing is performed is differential privacy-based service data obtained after the terminal device performs differential privacy processing on the obtained service data based on a privacy preserving rule in a trusted execution environment of the terminal device. The label obtaining module 1003 is configured to: based on the first smart contract, obtain risk label information corresponding to the service data by using the trusted application, and transfer the risk label information to the trusted execution environment. The risk determining module 1004 is configured to: based on the first smart contract, perform, in the trusted execution environment based on the risk label information and the obtained service data on which differential privacy processing is performed, aggregation analysis processing on the service data on which differential privacy processing is performed and that is from the different terminal devices, to determine risk information corresponding to the service data.

In some embodiments, the apparatus further includes: a feature sending module (not shown), configured to send, to the terminal device based on a second smart contract pre-deployed in the blockchain system, a data feature of service data whose risk information is that a risk exists, where the data feature is used by the terminal device to perform risk detection on the target service.

In the embodiments, the data processing apparatus includes a trusted execution environment. The service data of the target service is obtained by using the trusted application corresponding to the target service, and the service data is transferred to the trusted execution environment. The privacy preserving rule for performing differential privacy processing on the service data of the target service is set in the trusted execution environment. Differential privacy processing can be performed on the service data based on the privacy preserving rule in the trusted execution environment, to obtain the differential privacy-based service data; and the differential privacy-based service data can be transferred to the trusted execution environment of the server. Further, the server obtains the risk label information corresponding to the service data, and the risk information corresponding to the service data is determined based on the risk information and the differential privacy-based service data in the trusted execution environment of the server. In this way, a cloud-end privacy data search solution based on the trusted execution environment is provided in the above-mentioned manner, to perform analysis processing on information that is not authorized by a user, so as to ensure security of the calculation process, and ensure security of the calculation result. In addition, the trusted execution environment is a security zone established by software and hardware on a data calculation platform, to ensure that code and data loaded in the security zone are protected in terms of confidentiality and integrity and security is high.

Each module/unit in the above apparatus can be implemented with software, hardware, or a combination of software and hardware.

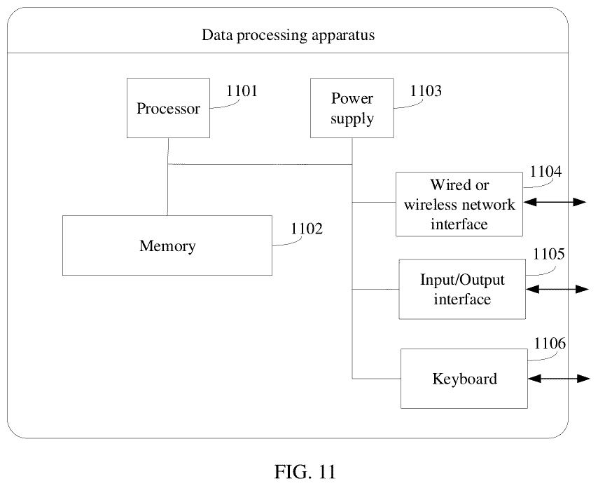

FIG. 11 is a schematic diagram of a data processing apparatus, according to an embodiment. The data processing apparatus includes a trusted execution environment. The data processing apparatus can be the terminal device, the server, or the apparatus in the blockchain system described above.

The data processing apparatus can differ greatly because of a difference in configuration or performance, and can include one or more processors 1101 and one or more memories 1102. The memory 1102 can store one or more applications or data. The application can include one or more modules (not shown), and each module can include a series of computer-executable instructions in the data processing apparatus. The processor 1101 can be configured to communicate with the memory 1102 to execute, on the data processing apparatus, a series of computer-executable instructions in the memory 1102. The data processing apparatus can further include one or more power supplies 1103, one or more wired or wireless network interfaces 1104, one or more input/output interfaces 1105, one or more keyboards 1106, etc.

The data processing apparatus can be the terminal device described above. Accordingly, in some embodiments, the one or more processors are configured to perform: obtaining service data of a target service by using a trusted application corresponding to the target service, and transferring the service data to the trusted execution environment, where a privacy preserving rule for performing differential privacy processing on the service data of the target service is set in the trusted execution environment; performing differential privacy processing on the service data based on the privacy preserving rule in the trusted execution environment, to obtain differential privacy-based service data; and transferring the differential privacy-based service data to a trusted execution environment of a server, to trigger the server to obtain risk label information corresponding to the service data, and to determine risk information corresponding to the service data based on the risk information and the differential privacy-based service data in the trusted execution environment of the server.

In some embodiments, the obtaining service data of the target service by using a trusted application corresponding to the target service, and transferring the service data to the trusted execution environment includes: obtaining the service data of the target service by using the trusted application corresponding to the target service, and transferring the service data to the trusted execution environment in a ciphertext manner by using the trusted application.

In some embodiments, the one or more processors are further configured to perform: receiving an update request for the privacy preserving rule in the trusted execution environment, where the update request includes to-be-updated rule data, and the to-be-updated rule data is a ciphertext; transferring the to-be-updated rule data to the trusted execution environment by using the trusted application; and in the trusted execution environment, decrypting the to-be-updated rule data, and updating the privacy preserving rule based on decrypted to-be-updated rule data.

In some embodiments, the privacy preserving rule is set based on at least one of: a privacy preserving rule established based on a differential privacy algorithm of a Laplace mechanism; or a privacy preserving rule established based on a differential privacy algorithm of an exponential mechanism.

In some embodiments, the transferring the differential privacy-based service data to a trusted execution environment of a server includes: encrypting the differential privacy-based service data in the trusted execution environment, to obtain encrypted data; and transferring the encrypted data to the trusted execution environment of the server by using the trusted application.

In some embodiments, an uploading probability is set for the service data, and the transferring the service data to the trusted execution environment includes: determining, based on the uploading probability corresponding to the service data, whether the service data needs to be uploaded to the server; and transferring the service data to the trusted execution environment if yes.

The data processing apparatus can be the server described above. Accordingly, in some embodiments, the one or more processors are configured to perform: obtaining, from different terminal devices by using a trusted application corresponding to a target service, service data that is of the target service and on which differential privacy processing is performed, and transferring the service data to the trusted execution environment, where the service data on which differential privacy processing is performed is differential privacy-based service data obtained after the terminal device performs differential privacy processing on the obtained service data based on a privacy preserving rule in a trusted execution environment of the terminal device; obtaining risk label information corresponding to the service data by using the trusted application, and transferring the risk label information to the trusted execution environment; and performing, in the trusted execution environment based on the risk label information and the obtained service data on which differential privacy processing is performed, aggregation analysis processing on the service data on which differential privacy processing is performed and that is from the different terminal devices, to determine risk information corresponding to the service data.

In some embodiments, the performing, in the trusted execution environment based on the risk label information and the obtained service data on which differential privacy processing is performed, aggregation analysis processing on the service data on which differential privacy processing is performed and that is from the different terminal devices, to determine risk information corresponding to the service data includes: grouping the service data on which differential privacy processing is performed and that is from the different terminal devices, to obtain a plurality of pieces of group data; performing aggregation analysis processing on service data in each piece of group data, to determine a risk value corresponding to each piece of group data; and determining the risk information corresponding to the service data based on the risk value corresponding to each piece of group data and a weight corresponding to each piece of group data.

In some embodiments, the grouping the service data on which differential privacy processing is performed and that is from the different terminal devices, to obtain a plurality of pieces of group data includes: grouping, in an equal-width or equal-frequency manner, the service data on which differential privacy processing is performed and that is from the different terminal devices, to obtain the plurality of pieces of group data.

In some embodiments, the one or more processors are further configured to perform: sending, to the terminal device, a data feature of service data whose risk information is that a risk exists, where the data feature is used by the terminal device to perform risk detection on the target service.

The data processing apparatus can be the apparatus in the blockchain system described above. Accordingly, in some embodiments, the one or more processors are configured to perform: obtaining risk detection rule information of service data of a target service, generating a corresponding first smart contract based on the risk detection rule information, and deploying the first smart contract in the blockchain system; based on the first smart contract, obtaining, from different terminal devices by using a trusted application corresponding to the target service, service data that is of the target service and on which differential privacy processing is performed, and transferring the service data to the trusted execution environment, where the service data on which differential privacy processing is performed is differential privacy-based service data obtained after the terminal device performs differential privacy processing on the obtained service data based on a privacy preserving rule in a trusted execution environment of the terminal device; based on the first smart contract, obtaining risk label information corresponding to the service data by using the trusted application, and transferring the risk label information to the trusted execution environment; and based on the first smart contract, performing, in the trusted execution environment based on the risk label information and the obtained service data on which differential privacy processing is performed, aggregation analysis processing on the service data on which differential privacy processing is performed and that is from the different terminal devices, to determine risk information corresponding to the service data.

In some embodiments, the one or more processors are further configured to perform: sending, to the terminal device based on a second smart contract pre-deployed in the blockchain system, a data feature of service data whose risk information is that a risk exists, where the data feature is used by the terminal device to perform risk detection on the target service.

In the above embodiments, the service data of the target service is obtained by using the trusted application corresponding to the target service, and the service data is transferred to the trusted execution environment. The privacy preserving rule for performing differential privacy processing on the service data of the target service is set in the trusted execution environment. Differential privacy processing can be performed on the service data based on the privacy preserving rule in the trusted execution environment, to obtain the differential privacy-based service data; and the differential privacy-based service data can be transferred to the trusted execution environment of the server. Further, the server obtains the risk label information corresponding to the service data, and the risk information corresponding to the service data is determined based on the risk information and the differential privacy-based service data in the trusted execution environment of the server. In this way, a cloud-end privacy data search solution based on the trusted execution environment is provided in the above-mentioned manner, to perform analysis processing on information that is not authorized by a user, so as to ensure security of the calculation process, and ensure security of the calculation result. In addition, the trusted execution environment is a security zone established by software and hardware on a data calculation platform, to ensure that code and data loaded in the security zone are protected in terms of confidentiality and integrity and security is high.

Embodiments of this specification further provide a non-transitory computer-readable storage medium having stored thereon instructions that, when executed by a processor, cause the processor to perform any one of the data processing methods described above. For example, the storage medium can be a USB flash drive, an optical disc, a hard disk, etc.

For example, the data processing method can include: obtaining service data of a target service by using a trusted application corresponding to the target service, and transferring the service data to a trusted execution environment, where a privacy preserving rule for performing differential privacy processing on the service data of the target service is set in the trusted execution environment; performing differential privacy processing on the service data based on the privacy preserving rule in the trusted execution environment, to obtain differential privacy-based service data; and transferring the differential privacy-based service data to a trusted execution environment of a server, to trigger the server to obtain risk label information corresponding to the service data, and to determine risk information corresponding to the service data based on the risk information and the differential privacy-based service data in the trusted execution environment of the server.

In some embodiments, the obtaining service data of the target service by using a trusted application corresponding to the target service, and transferring the service data to the trusted execution environment includes: obtaining the service data of the target service by using the trusted application corresponding to the target service, and transferring the service data to the trusted execution environment in a ciphertext manner by using the trusted application.

In some embodiments, the method further includes: receiving an update request for the privacy preserving rule in the trusted execution environment, where the update request includes to-be-updated rule data, and the to-be-updated rule data is a ciphertext; transferring the to-be-updated rule data to the trusted execution environment by using the trusted application; and in the trusted execution environment, decrypting the to-be-updated rule data, and updating the privacy preserving rule based on decrypted to-be-updated rule data.

In some embodiments, the privacy preserving rule is set based on at least one of: a privacy preserving rule established based on a differential privacy algorithm of a Laplace mechanism; or a privacy preserving rule established based on a differential privacy algorithm of an exponential mechanism.

In some embodiments, the transferring the differential privacy-based service data to a trusted execution environment of a server includes: encrypting the differential privacy-based service data in the trusted execution environment, to obtain encrypted data; and transferring the encrypted data to the trusted execution environment of the server by using the trusted application.

In some embodiments, an uploading probability is set for the service data, and the transferring the service data to the trusted execution environment includes: determining, based on the uploading probability corresponding to the service data, whether the service data needs to be uploaded to the server; and transferring the service data to the trusted execution environment if yes.

Also for example, the data processing method can include: obtaining, from different terminal devices by using a trusted application corresponding to a target service, service data that is of the target service and on which differential privacy processing is performed, and transferring the service data to the trusted execution environment, where the service data on which differential privacy processing is performed is differential privacy-based service data obtained after the terminal device performs differential privacy processing on the obtained service data based on a privacy preserving rule in a trusted execution environment of the terminal device; obtaining risk label information corresponding to the service data by using the trusted application, and transferring the risk label information to the trusted execution environment; and performing, in the trusted execution environment based on the risk label information and the obtained service data on which differential privacy processing is performed, aggregation analysis processing on the service data on which differential privacy processing is performed and that is from the different terminal devices, to determine risk information corresponding to the service data.

In some embodiments, the performing, in the trusted execution environment based on the risk label information and the obtained service data on which differential privacy processing is performed, aggregation analysis processing on the service data on which differential privacy processing is performed and that is from the different terminal devices, to determine risk information corresponding to the service data includes: grouping the service data on which differential privacy processing is performed and that is from the different terminal devices, to obtain a plurality of pieces of group data; performing aggregation analysis processing on service data in each piece of group data, to determine a risk value corresponding to each piece of group data; and determining the risk information corresponding to the service data based on the risk value corresponding to each piece of group data and a weight corresponding to each piece of group data.

In some embodiments, the grouping the service data on which differential privacy processing is performed and that is from the different terminal devices, to obtain a plurality of pieces of group data includes: grouping, in an equal-width or equal-frequency manner, the service data on which differential privacy processing is performed and that is from the different terminal devices, to obtain the plurality of pieces of group data.

In some embodiments, the method further includes: sending, to the terminal device, a data feature of service data whose risk information is that a risk exists, where the data feature is used by the terminal device to perform risk detection on the target service.

Also for example, the data processing method can include: obtaining risk detection rule information of service data of a target service, generating a corresponding first smart contract based on the risk detection rule information, and deploying the first smart contract in the blockchain system; based on the first smart contract, obtaining, from different terminal devices by using a trusted application corresponding to the target service, service data that is of the target service and on which differential privacy processing is performed, and transferring the service data to the trusted execution environment, where the service data on which differential privacy processing is performed is differential privacy-based service data obtained after the terminal device performs differential privacy processing on the obtained service data based on a privacy preserving rule in a trusted execution environment of the terminal device; based on the first smart contract, obtaining risk label information corresponding to the service data by using the trusted application, and transferring the risk label information to the trusted execution environment; and based on the first smart contract, performing, in the trusted execution environment based on the risk label information and the obtained service data on which differential privacy processing is performed, aggregation analysis processing on the service data on which differential privacy processing is performed and that is from the different terminal devices, to determine risk information corresponding to the service data.

In some embodiments, the method further includes: sending, to the terminal device based on a second smart contract pre-deployed in the blockchain system, a data feature of service data whose risk information is that a risk exists, where the data feature is used by the terminal device to perform risk detection on the target service.

In the embodiments, the service data of the target service is obtained by using the trusted application corresponding to the target service, and the service data is transferred to the trusted execution environment. The privacy preserving rule for performing differential privacy processing on the service data of the target service is set in the trusted execution environment. Differential privacy processing can be performed on the service data based on the privacy preserving rule in the trusted execution environment, to obtain the differential privacy-based service data; and the differential privacy-based service data can be transferred to the trusted execution environment of the server. Further, the server obtains the risk label information corresponding to the service data, and the risk information corresponding to the service data is determined based on the risk information and the differential privacy-based service data in the trusted execution environment of the server. In this way, a cloud-end privacy data search solution based on the trusted execution environment is provided in the above-mentioned manner, to perform analysis processing on information that is not authorized by a user, so as to ensure security of the calculation process, and ensure security of the calculation result. In addition, the trusted execution environment is a security zone established by software and hardware on a data calculation platform, to ensure that code and data loaded in the security zone are protected in terms of confidentiality and integrity and security is high.

The data processing methods described above can be implemented by an integrated circuit, such as a programmable logic device (PLD) (for example, a field programmable gate array (FPGA)). A designer can autonomously perform programming to integrate a digital system onto a PLD, without requesting a chip manufacturer to design and manufacture a dedicated integrated circuit chip. In addition, currently, instead of manually manufacturing an integrated circuit chip, such programming is usually implemented by using logic compiler software. The logic compiler software is similar to a software compiler used during program development and writing. Original code to be compiled needs to be written in a specific programming language. The specific programming language is referred to as a hardware description language (HDL). There is not only one HDL, but there are many HDLs such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). Currently, Very-High-Speed Integrated Circuit Hardware Description Language (VHDL) and Verilog are commonly used. It should also be clear to a person skilled in the art that a hardware circuit for implementing a logical method procedure can be easily obtained by performing slight logic programming on the method procedure by using the above hardware description languages and programming the method procedure into an integrated circuit.

The data processing methods described above can be implemented by a controller. The controller may be implemented in any suitable manner. For example, the controller may be in a form of a microprocessor or a processor and a computer-readable medium storing computer-readable program code (for example, software or firmware) that can be executed by the (micro) processor, a logic gate, a switch, an application-specific integrated circuit (ASIC), a programmable logic controller, and an embedded microcontroller. A storage controller can further be implemented as a part of control logic of a storage. A person skilled in the art also knows that, in addition to implementing the controller by using only computer-readable program code, logic programming may be performed on a method step, so that the controller implements the same function in a form of a logic gate, a switch, an application-specific integrated circuit, a programmable logic controller, an embedded microcontroller, etc. Therefore, the controller may be considered as a hardware component, and an apparatus included in the controller and configured to implement various functions may also be considered as a structure in the hardware component. Alternatively, an apparatus for implementing various functions may be considered as a software module that can implement a method or a structure in the hardware component.

The system, apparatus, module, or unit described in the above embodiments can be implemented by a computer chip or entity, or may be implemented by a product that has a specific function. A typical implementation device is a computer. The computer can be, for example, a personal computer, a laptop computer, a cellular phone, a camera phone, a smartphone, a personal digital assistant, a media player, a navigation device, an e-mail device, a game console, a tablet computer, a wearable device, or any combination of these devices.

The data processing methods described above can be implemented by a computing device. In a typical configuration, the computing device includes one or more processors (CPU), an input/output interface, a network interface, and a memory.

The memory may include at least one of a non-persistent memory, a random access memory (RAM), and/or a nonvolatile memory in a computer-readable medium, for example, a read-only memory (ROM) or a flash read-only memory (flash RAM). The memory is an example of the computer-readable medium.

The computer-readable medium includes persistent, non-persistent, movable, and unmovable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information that can be accessed by the computing device. As described in this specification, the computer-readable medium does not include computer-readable transitory media (transitory media) such as a modulated data signal and a carrier.

Examples of embodiments of this specification are described above. Other embodiments fall within the scope of the appended claims. In some cases, the actions or steps described in the claims can be performed in an order different from that in the embodiments, and the desired results can still be achieved. In addition, the process depicted in the accompanying drawings does not necessarily need a particular sequence or consecutive sequence to achieve the desired results. In some implementations, multi-tasking and parallel processing are feasible or may be advantageous.

The terms “include”, “comprise”, or any other variant thereof are intended to cover a non-exclusive inclusion such that a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product, or device that includes the element.

A person skilled in the art should understand that the embodiments of the present specification can be provided as a method, a system, or a computer program product. Therefore, one or more embodiments of this specification can be implemented with hardware, software, or a combination of software and hardware.

One or more embodiments of this specification can be implemented in the general context of computer-executable instructions executed by a computer, for example, a program module. Typically, the program module includes a routine, a program, an object, a component, a data structure, etc. that performs a specific task or implement a specific abstract data type. One or more embodiments of this specification can alternatively be practiced in distributed computing environments where tasks are performed by remote processing devices that are connected through a communication network. In the distributed computing environment, a program module can be located in local and remote computer storage media including a storage device.

The above descriptions are merely examples of embodiments of this specification, and are not intended to limit this specification. A person skilled in the art can make various modifications or changes to this specification. Any modification, equivalent replacement, or improvement made without departing from the spirit and principle of this application shall fall within the scope of the claims of this specification.

What is claimed is:

1. A data processing method, applied to a terminal device, the method comprising:
obtaining service data of a target service by using a trusted application corresponding to the target service, and transferring the service data of the target service to a trusted execution environment of the terminal device, wherein a privacy preserving rule for performing differential privacy processing on the service data of the target service is set in the trusted execution environment of the terminal device;
performing differential privacy processing on the service data of the target service based on the privacy preserving rule in the trusted execution environment of the terminal device, to obtain differential privacy-based service data; and
transferring the differential privacy-based service data to a trusted execution environment of a server, to trigger the server to obtain risk label information corresponding to the service data of the target service, and to determine risk information corresponding to the service data of the target service based on the risk label information and the differential privacy-based service data in the trusted execution environment of the server.

2. The method according to claim 1, wherein the transferring the service data of the target service to the trusted execution environment of the terminal device comprises:
transferring the service data of the target service to the trusted execution environment of the terminal device in a ciphertext manner by using the trusted application.

3. The method according to claim 1, further comprising:
receiving an update request for the privacy preserving rule in the trusted execution environment of the terminal device, wherein the update request comprises to-be-updated rule data, and the to-be-updated rule data is a ciphertext;
transferring the to-be-updated rule data to the trusted execution environment of the terminal device by using the trusted application; and
in the trusted execution environment of the terminal device, decrypting the to-be-updated rule data, and updating the privacy preserving rule based on the decrypted to-be-updated rule data.

4. The method according to claim 3, wherein the privacy preserving rule is set based on at least one of:
a privacy preserving rule established based on a differential privacy algorithm of a Laplace mechanism; or
a privacy preserving rule established based on a differential privacy algorithm of an exponential mechanism.

5. The method according to claim 1, wherein the transferring the differential privacy-based service data to the trusted execution environment of the server comprises:
encrypting the differential privacy-based service data in the trusted execution environment of the terminal device, to obtain encrypted data; and
transferring the encrypted data to the trusted execution environment of the server by using the trusted application.

6. The method according to claim 5, wherein an uploading probability is set for the service data of the target service, and the transferring the service data of the target service to the trusted execution environment of the terminal device comprises:
determining, based on the uploading probability corresponding to the service data, whether the service data needs to be uploaded to the server; and
transferring, in response to a determination that the service data needs to be uploaded to the server, the service data to the trusted execution environment of the terminal device.

7. A data processing method, applied to a server, the method comprising:
obtaining differential privacy-based service data from different terminal devices by using a trusted application corresponding to a target service, and transferring the differential privacy-based service data to a trusted execution environment of the server, wherein the differential privacy-based service data is obtained after a terminal device performs differential privacy processing on service data of the target service based on a privacy preserving rule in a trusted execution environment of the terminal device;
obtaining risk label information corresponding to the service data of the target service by using the trusted application, and transferring the risk label information to the trusted execution environment of the server; and
performing in the trusted execution environment of the server, based on the risk label information and the differential privacy-based service data, aggregation analysis processing on the differential privacy-based service data from the different terminal devices, to determine risk information corresponding to the service data of the target service.

8. The method according to claim 7, wherein the performing in the trusted execution environment of the server the aggregation analysis processing comprises:
grouping the differential privacy-based service data from the different terminal devices, to obtain a plurality of pieces of group data;
performing aggregation analysis processing on service data in each piece of group data, to determine a risk value corresponding to each piece of group data; and
determining the risk information corresponding to the service data of the target service based on the risk value corresponding to each piece of group data and a weight corresponding to each piece of group data.

9. The method according to claim 8, wherein the grouping the differential privacy-based service data from the different terminal devices to obtain the plurality of pieces of group data comprises:
grouping, in an equal-width or equal-frequency manner, the differential privacy-based service data from the different terminal devices, to obtain the plurality of pieces of group data.

10. The method according to claim 7, further comprising:
sending, to the terminal device, a data feature of service data whose risk information is that a risk exists, wherein the data feature is used by the terminal device to perform risk detection on the target service.

11. A data processing apparatus, applied to a terminal device, the apparatus comprising:
a processor; and
a memory storing instructions executable by the processor,
wherein the processor is configured to:
obtain service data of a target service by using a trusted application corresponding to the target service, and transfer the service data of the target service to a trusted execution environment of the terminal device, wherein a privacy preserving rule for performing differential privacy processing on the service data of the target service is set in the trusted execution environment of the terminal device;
perform differential privacy processing on the service data of the target service based on the privacy preserving rule in the trusted execution environment of the terminal device, to obtain differential privacy-based service data; and
transfer the differential privacy-based service data to a trusted execution environment of a server, to trigger the server to obtain risk label information corresponding to the service data of the target service, and to determine risk information corresponding to the service data of the target service based on the risk label information and the differential privacy-based service data in the trusted execution environment of the server.

12. The apparatus according to claim 11, wherein the processor is further configured to:
transfer the service data of the target service to the trusted execution environment of the terminal device in a ciphertext manner by using the trusted application.

13. The apparatus according to claim 11, wherein the processor is further configured to:
receive an update request for the privacy preserving rule in the trusted execution environment of the terminal device, wherein the update request comprises to-be-updated rule data, and the to-be-updated rule data is a ciphertext;
transfer the to-be-updated rule data to the trusted execution environment of the terminal device by using the trusted application; and
in the trusted execution environment of the terminal device, decrypt the to-be-updated rule data, and update the privacy preserving rule based on the decrypted to-be-updated rule data.

14. The apparatus according to claim 13, wherein the privacy preserving rule is set based on at least one of:
a privacy preserving rule established based on a differential privacy algorithm of a Laplace mechanism; or
a privacy preserving rule established based on a differential privacy algorithm of an exponential mechanism.

15. The apparatus according to claim 11, wherein the processor is further configured to:
encrypt the differential privacy-based service data in the trusted execution environment of the terminal device, to obtain encrypted data; and
transfer the encrypted data to the trusted execution environment of the server by using the trusted application.

16. The apparatus according to claim 15, wherein an uploading probability is set for the service data of the target service, and the processor is further configured to:
determine, based on the uploading probability corresponding to the service data, whether the service data needs to be uploaded to the server; and
transfer, in response to a determination that the service data needs to be uploaded to the server, the service data to the trusted execution environment of the terminal device.

17. A data processing apparatus, applied to a server, the apparatus comprising:
a processor; and
a memory storing instructions executable by the processor,
wherein the processor is configured to perform the data processing method according to claim 7.

18. A non-transitory computer-readable storage medium storing instructions that, when executed by a processor, cause the processor to perform the data processing method according to claim 1.

19. A non-transitory computer-readable storage medium storing instructions that, when executed by a processor, cause the processor to perform the data processing method according to claim 7.
